(19) United States
(12) Patent Application Publication
(10) Pub. No.: US 2022/0117415 A1
(43) Pub. Date: Apr. 21, 2022

(54) MIRROR SYSTEM WITH WIDE RANGING COUPLING MECHANISM AND METHOD OF USING THE SAME

(71) Applicant: Gooru Inc., Canton, MA (US)

(72) Inventors: Patrick Fernsten, Canton, MA (US); Aleh Kadolka, Canton, MA (US); Aleh Bardziyan, Canton, MA (US); Vitali Murach, Canton, MA (US)

(21) Appl. No.: 17/502,877

(22) Filed: Oct. 15, 2021

Related U.S. Application Data
(60) Provisional application No. 63/092,536, filed on Oct. 16, 2020.

(51) Int. Cl. A47G 1/02; A47G 1/16

(52) U.S. Cl. CPC A47G 1/02; A47G 1/1653

(57) ABSTRACT

A mirror system for use with a stroller or wheelchair has a mirror, a support arm coupled with the mirror, and a clamp coupled with the support arm. The mirror is spaced from the clamp along the support arm. The clamp can couple with a wide variety of different support bases. To that end, the clamp of this embodiment has a first member with a first surface and a second member having a second surface. The first surface opposes the second surface and is compressible. The second surface has a concavity. To be removably couplable with a support base, the first surface is movable relative to the second surface.

### PRIORITY

This patent application claims priority from provisional U.S. patent application No. 63/092,536, filed Oct. 16, 2020, entitled, “ATTACHABLE REVIEW MIRROR,” and naming Patrick Fernsten as inventor, the disclosure of which is incorporated herein, in its entirety, by reference.

### GOVERNMENT RIGHTS

None

### FIELD

Illustrative embodiments of the generally relate to mirror systems for movable devices and, more particularly, various embodiments relate to a mirror system that enhances eye-to-eye interaction with a person supported in a stroller or wheelchair.

### BACKGROUND

Eye contact detection typically happens in the first two to five days of life for humans. Infants stay highly responsive to parental engagement and highly aware of neglect. It is widely believed that eye contact and communication are critical for accelerated human development from the earliest days of life through the first few years. Babies' brains from birth to five years of age are awash with the vital hormone, Brain-Derived Neurotrophic Factor (BDNF), responsible for memory, imagination, dendrite growth, and neurogenesis. Eye-to-eye communication may stimulate BDNF, and at the very least, lead to improved communicative and language development in young children.

### SUMMARY OF VARIOUS EMBODIMENTS

In accordance with one embodiment of the invention, a mirror system for use with a stroller or wheelchair has a mirror, a support arm coupled with the mirror, and a clamp coupled with the support arm. The mirror is spaced from the clamp along the support arm. The clamp can couple with a wide variety of different support bases. To that end, the clamp of this embodiment has a first member with a first surface and a second member having a second surface. The first surface opposes the second surface and is compressible. The second surface has a concavity. To be removably couplable with a support base, the first surface is movable relative to the second surface.

The mirror may take on a variety of forms, such as by having a convex reflective surface. The support arm preferably comprises a gooseneck having a flexible longitudinal member formed from a plurality of interconnected ring elements. This enables flexibility of positioning while firmness for anticipated uses.

The clamp may have a hinge pivotably coupling the first member and the second member at an axis. The hinge thus is configured so that the first surface can move toward and away from the second surface. As an angled relationship, the first surface may be considered to at least partially faces the second surface. Alternatively, the first member may be configured to move substantially perpendicularly toward and/or away from the second member.

The concavity can take on a variety of different geometries. For example the concavity may form an angled surface having an angle between 90 and 175 degrees. Alternatively, the concavity may form a curved surface—preferably having a large radius. The concavity may have a prescribed depth for coupling with a securing base. To that end, the second member may have a portion with a maximum thickness, while the concavity has a maximum depth into the second member. The ratio of the maximum depth and the thickness of the second member may be between 0.1 and 0.6.

The first member may be formed to have a rigid inner layer (e.g., a plastic layer) and an outer silicone or rubber forming the first surface. To provide a better removable coupling, at least one of the first and second members may have a descending lip configured to form a containment chamber for supporting a base member. The descending lip preferably has a compressible inner lip surface. In either case, the first and second surfaces may be configured to cooperate to secure to a flat surface with at least a portion of the support arm being held upright. In addition, the first and second surfaces also may be configured to cooperate to secure to a convex surface with at least a portion of the support arm being held upright.

In accordance with another embodiment, a method provides a movable platform (e.g., a stroller or wheelchair) having wheels and a base member, a seat configured to support a person, and a handle configured to enable application of a force to move the movable platform (e.g., a person pushing a stroller). The method removably secures a mirror system to the base member of the movable platform. Preferably, the mirror system has a support arm coupled with both a mirror and a clamp, and the clamp has a first member having a first surface and a second member having a second surface. In a manner similar to other embodiments, the first surface opposes the second surface and is compressible, and the second surface has a concavity and is movable relative to the first surface.

To secure, the method may secure the clamp to the base member so that at least a portion of the support arm is held upright. To that end, a securing force (e.g., via a spring) is applied to the first and second members of the clamp so that the first member is biased at least partially toward the second member. The securing force at least partially deforms and compresses the compressible first surface against the base member. In addition, the concavity of the second surface contacts with the base member of the movable platform. The method then may adjust the position of the mirror relative to the base while the clamp is removably secured to the base. To that end, the support arm may be moved so that part or all of it moves so that the mirror at least partially faces in the direction of the handle.

In accordance with other embodiments, a mirror system has a mirror with a convex reflective surface, a flexible gooseneck support arm coupled with the mirror, and a clamp coupled with the support arm. The support arm has a plurality of individual interconnected ring elements that are movable relative to each other to enable the support arm to change shapes in response to an applied force. The clamp has a first member with a first surface and a second member with a second surface. The first surface opposes the second surface and is compressible, while the second surface has a concavity that forms one of a curved surface or an angled surface. The first surface is movable relative to the second surface about a common axis to form a hinge.

In this other embodiment, the first and second surfaces are configured to cooperate to secure to a flat surface with at least a portion of the support arm being held upright. The first and second surfaces also are configured to cooperate to secure to a convex surface with at least a portion of the support arm being held upright. At least one of the first and second members has a descending lip configured to form a containment chamber for supporting a base member. For improved securing, the descending lip has a compressible inner lip surface.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 schematically shows a stroller having a mirror system configured in accordance with illustrative embodiments.

FIG. 2 schematically shows the mirror of FIG. 1 coupled/secured with a base member.

FIG. 3 schematically shows a broken apart view of one embodiment of the mirror system of FIG. 1.

FIGS. 4A-4F schematically show various side and partial cut-away views of a clamp used in illustrative embodiments. Each view shows a removable coupling with a base member having a different cross-sectional shape and/or size.

### DESCRIPTION OF ILLUSTRATIVE EMBODIMENTS

In illustrative embodiments, a mirror system can removably secure to a wider variety of movable platforms. To that end the mirror system has a support member coupled with both a mirror and a specially configured clamp. Preferably, the clamp is configured to removably secure with a wide variety of types of base members/securing members of the movable platform. For example, the base member may be rounded, flat, or some combination thereof. Importantly, the removable connection is stable enough to ensure that the mirror can remain substantially upright while connected to the base member. Initial expected uses may be for strollers or wheelchairs. Details of illustrative embodiments are discussed below.

Children are typically placed in forward-facing strollers at six months of age, or when they are able to sit up on their own, allowing the child to see the world around them. This near-universal action ends child eye contact and limits communication with parents and caregivers pushing a stroller. When illustrative embodiments of the mirror system are attached to a stroller, typically developing children will look into the mirror on their own, when their name is called, or when they are directed to by a caregiver. Through the purposed, convex mirror, the child typically makes eye contact and interacts with their caregiver more, building the baby's brain with each interaction while out on a walk or run. The mirror preferably is large enough to ensure a clear view of eye contact between children and parents/caregivers pushing the stroller.

Additionally, for runners using illustrative embodiments, children typically witness effort and resilience as parents push themselves and their child forward in a stroller. Research indicates children in strollers may learn about resilience and grit when exposed to resilience examples from parents, i.e., watching a parent pushing themselves on a run.

Based on existing research, the inventors recognized that illustrative embodiments of the mirror system have a strong likelihood of leading to widespread intellectual development benefits. Academic research has confirmed child brain benefits of eye-to-eye communication when parents interact with babies in person or over video. Presently, to the knowledge of the inventors, there is no relevant research on child brain development through mirror interactions.

The behavioral symptoms of autism spectrum disorder (ASD) often appear by 12 months to 18 months of age or earlier. Two relevant diagnostic indicators for ASD in children known to the inventor is:

1. Lack of eye contact

2. Not responding to their name

As such, children with ASD may not look into a stroller mirror to see themselves or to make eye contact with their caregiver. Those with later-onset ASD may initially engage through the discussed embodiments, but then noticeably stop engaging, even when directed to look into the mirror. For this reason, the mirror system may provide parents/caregivers/babysitters with an early detection mechanism for Autism symptoms. Early diagnosis and early treatment of ASD has been reported as leading to better outcomes.

After a child is diagnosed with ASD, there are dozens of different treatment options available. One such recommended treatment is Slow Habituation to Eye Contact in a Non-Therapeutic Environment. According to Nouchine Hadjikhani, MD, Ph.D., from the Harvard Medical School, “An approach involving slow habituation to eye contact may help children . . . be able to handle eye contact in the long run, thereby avoiding the cascading effects that eye-avoidance has on the development of the social brain.” By providing opportunities for habituation to eye contact while out on a daily stroller walk, the mirror system is an appropriate non-therapeutic environmental intervention for children diagnosed with ASD.

Children develop significant object permanence between 4-8 months of age, without yet developing a concept of time. They realize their parents exist when out of sight, yet often do not know their parent will return after they leave, which can cause a child to cry with fear. Children between eight months and one year old often are even more uncertain about being separated from a parent. This is when separation anxiety typically develops, and children may become agitated and upset when a parent is out of sight. The timing of separation anxiety can vary. Some kids might go through it later, between 18 months and 2.5 years of age.

Intense separation anxiety can last into elementary school or beyond and lead to:
panic symptoms (such as nausea, vomiting, or shortness of breath) or panic attacks before a parent leaves,
nightmares about separation,
fear of sleeping alone, and/or
excessive worry about being lost or kidnapped or going places without a parent.

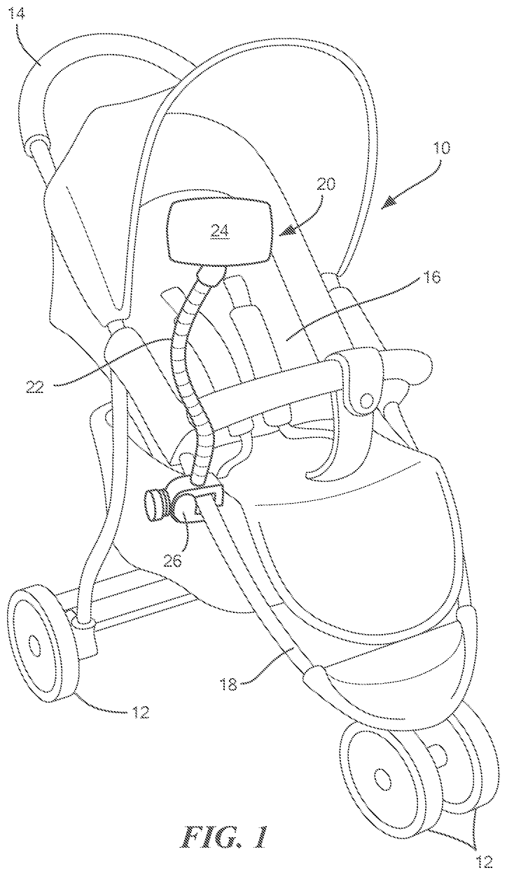

Various embodiments aim to mitigate these issues by enabling eye-to-eye contact when in a movable platform, such as a stroller or wheelchair. To that end, FIG. 1 schematically shows a stroller 10 (i.e., an example of a movable platform) that may use illustrative embodiments. As with many other similar devices, the stroller 10 of FIG. 1 has a frame supporting a plurality of wheels 12, a handle 14 enabling a caregiver to apply a force to move the stroller 10, and a seating area 16 for holding a child. The stroller 10 also has a base member or other structure (hereinafter “base member 18”) to which a mirror system 20 may be removably coupled. As discussed below, the base member 18 may have any of a variety of topologies and cross-sectional shapes and yet, still be removably couplable with the mirror system 20 of various embodiments.

Undesirably, because they are not a standardized device, different strollers 10 may have a plurality of different components that may act as base members 18. The inventors recognized that this presented a significant problem—namely, they noticed that the multitude of different types of base members 18 can impede use of prior art mirror systems. Some may attach but then pivot so that the mirror does not stay firmly in place . . . or even not remain upright in the desired position enabling eye-to-eye contact. In particular, even though some prior art mirror systems may secure to a base member 18, they may rotate when subjected to minimal or expected forces during use so that their mirror is not upright—it is not in a position to appropriately view the child in the seating area 16. In other words, the mirror may be beneath base member 18. Prior art mirror systems known to the inventors are significantly limited in that they can couple with only a base member 18 having a specific type of topology/shape/size. For example, such prior art mirror systems may couple securely with flat base members only. After years of testing and failing, however, the inventors discovered a mirror system 18 with the versatility to removably couple with a wider variety of base members 18.

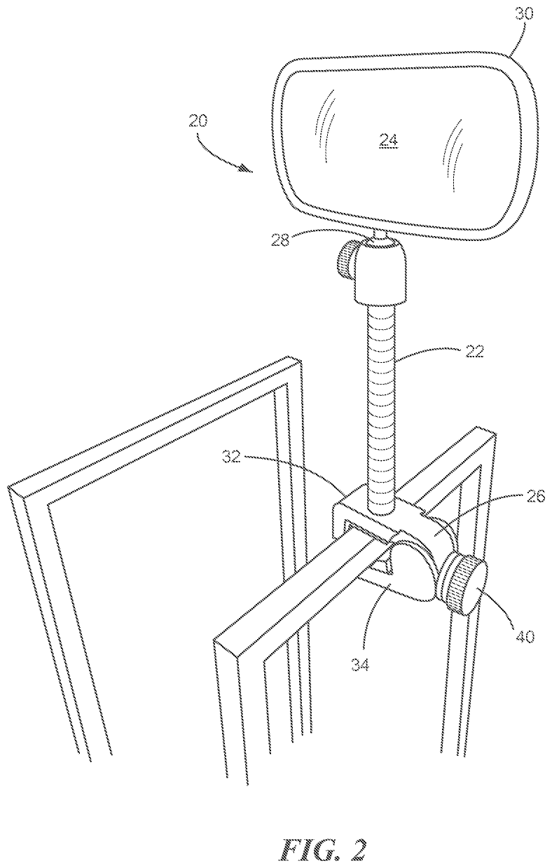

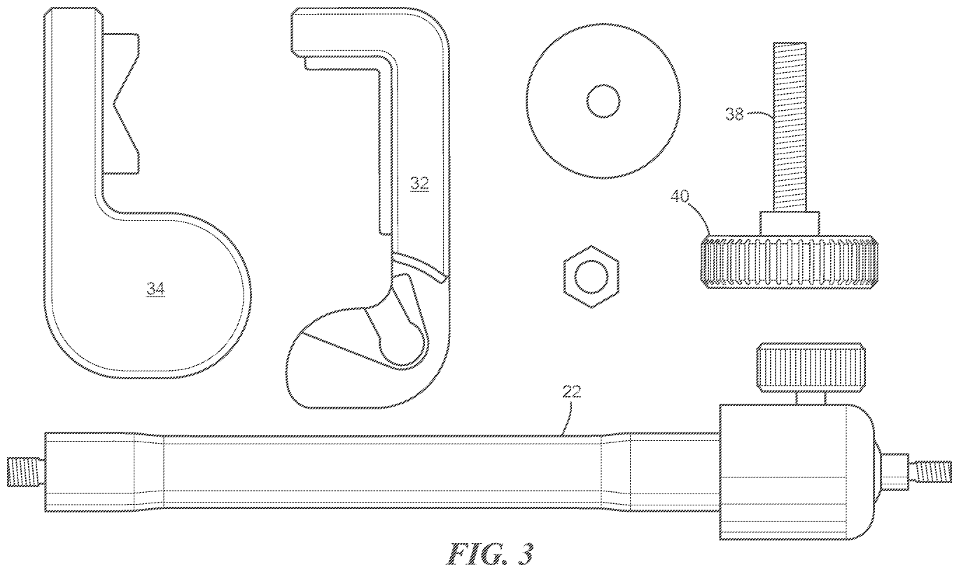

Specifically, as shown in more detail in FIG. 2, which shows the mirror system 20 in a closer view, and FIG. 3, which schematically shows a broken-apart view of the mirror system 20, the mirror system 20 has a support arm 22 coupled with the noted mirror (identified by reference number “24”) and a specially configured clamp 26. As shown, the mirror 24 is coupled at one end of the support arm 22 while the clamp 26 is coupled at the opposite end of the support arm 22. Alternative embodiments, however, may secure either or both of those components longitudinally inward of the end(s) of the support arm 22. Accordingly, while preferred, discussion of the mirror 24 and clamp 26 being at the two ends of the support arm 22 are for illustrative purposes only.

The mirror 24 may be any conventional reflective mirror, although preferred embodiments are formed as a wide-angle safety mirror 24, attached with a robust ball-joint 28 for improved maneuverability. Other embodiments may be attached without a ball-joint 28. To improve safety and enhance the view, the mirror 24 may be formed with an external reflective surface having a convex shape, enabling a wide field of view. The mirror's convex nature disperses and dissipates heat from the sun, reducing the risk of increased sun exposure to individuals looking at the mirror 24, or individuals positioned in front of the mirror 24. The mirror 24 may be fixedly secured to the support arm 22 or, as noted above, movably secured to the neck by some movable means, such as a sturdy ball-joint 28 for maximum maneuverability. This ball-joint 28 provides maneuverability and, when paired with the flexibility of the arm, provides the opportunity for maximum freedom of positioning (e.g., 360-degree positioning or additional degrees of freedom). This feature enables the unit to be securely positioned in a wide variety of locations and directions, and give a view of the immediate area behind the user.

Among other possible materials, the mirror casing 30 preferably is made from rubber and polished stainless steel, which ensures easy cleaning and disinfecting while providing durability and resistance to weather conditions, which is important for users who may leave the mirror 24 outside. In addition, the mirror 24 and casing 30 preferably are machined with smooth curves and angles, and wrapped with silicone rubber to ensure safety around all potential users. The mirror 24 may be screwed onto a rounded platform and glued with permanent epoxy.

Rather than being a mirror 24, some embodiments may be implemented as a video screen with a camera. For example, the mirror system 20 may comprise a smartphone that is configured to show a picture of the caregiver and/or the child during use.

The support arm's primary function is to stably support the mirror 24 in a desired orientation. Some embodiments may use a rigid arm 22 having all parts rigidly connected. In other words, in that embodiment, no part of the support arm 22 is movable relative to another part of the support arm 22. Other embodiments, however, may form the support arm 22 from a material or structure that permits its body to flex—in other words, one part of the arm in this embodiment may move relative to another portion of the support arm 22.

For example, the support arm 22 may be formed as a gooseneck arm configured to move with freedom of direction in three orthogonal dimensions (X, Y, and Z) and yet, remain substantially stable (when subjected to expected forces) after moved to a specific orientation. In fact, with the ball-joint 28, the mirror system 20 may have up to six degrees of freedom. To that end, in illustrative embodiments, the support arm 22 may be formed as a flexible, elongated member formed from a plurality of interconnected ring elements. For example, the support arm 22 may have a steel core.

Specifically, in illustrative embodiments, the support arm 22 may be formed from two ribbons of stainless steel molded together for support, then twisted into a gooseneck shape, before being fitted/screwed/glued/secured into stainless steel heads on each end. The unit is then wrapped in a protective, silicone sleeve for universal safety around children and additional support. Those skilled in the art may develop and test the support arm 22 to have the flexibility, rigidity, and freedom of movement for a given application and to desired specifications. Thus, under anticipated forces expected when used with a stroller 10 or wheelchair, the gooseneck-style arm flexibility preferably allows the mirror 24 to be stably positioned and secured in any of a plurality of directions and orientations and yet, no more than negligibly moves during use (e.g. when the stroller 10 is moving). The ability to secure the mirror 24 in a multitude of positions allows for a wide variety of rear-view applications.

The support arm's strength and agility enables the mirror 24 to stay in place once positioned in many applications securely. When attached to a moving object, the support arm 22 is designed to resist movement through bumps, wind, or sudden movement anticipated during typical use. This feature helps users who choose to attach the unit to a moving object, such as a baby stroller 10, wheelchair, or boat. Of course, the mirror 24 and support arm 22 are movable when directly grasped and moved by a user.

Yet other embodiments of the support arm 22 may be formed from a flexible, solid material, such as plastic, rubber, metal, or a combination of those materials, to stably support the mirror 24 in the manner noted above. For example, this other embodiment may be formed primarily with a flexible solid metal component, or a rubber/plastic malleable interior core material with a flexible outer layer.

Importantly, the clamp 26 securely attaches to any of a variety of frames with base members 18 having varying sizes, topologies, and cross-sectional shapes. When removably coupled, the clamp 26 preferably is configured so that it does not rotate about the axis of the base member 18 when the mirror system 20 is subjected to expected forces (e.g., indirect (non-contact) forces rather than direct forces). This should enable the mirror 24 to remain upright during use. Indeed, applying unanticipated high forces to the mirror system 20 certainly may cause a rotation or even a decoupling. Those skilled in the art should configure/design the clamp 26 for ranges of anticipated forces in the given application. That may include indirect forces such as bumps in the surface along with the stroller 10 is pushed, sudden stops and starts, gravity, etc.

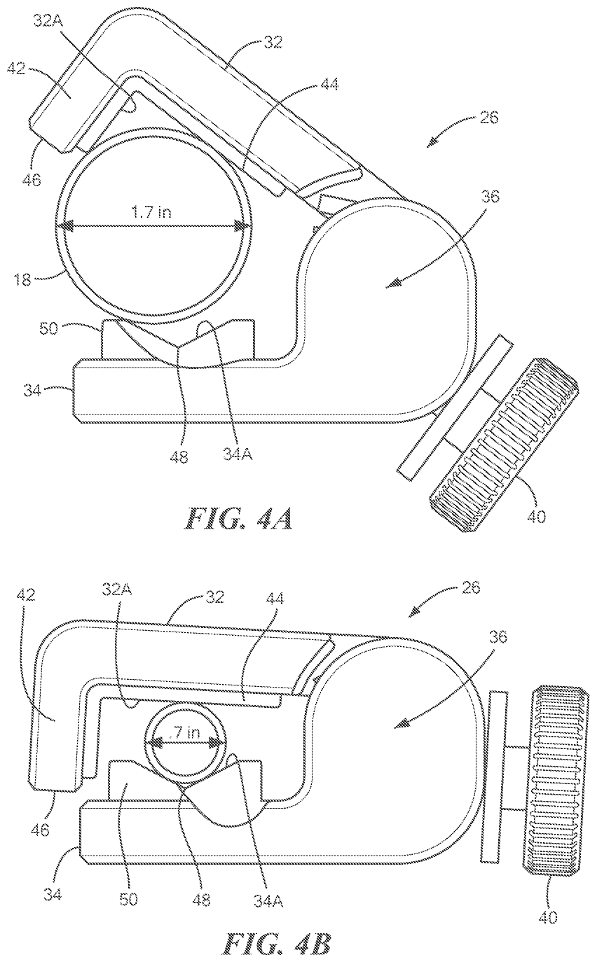

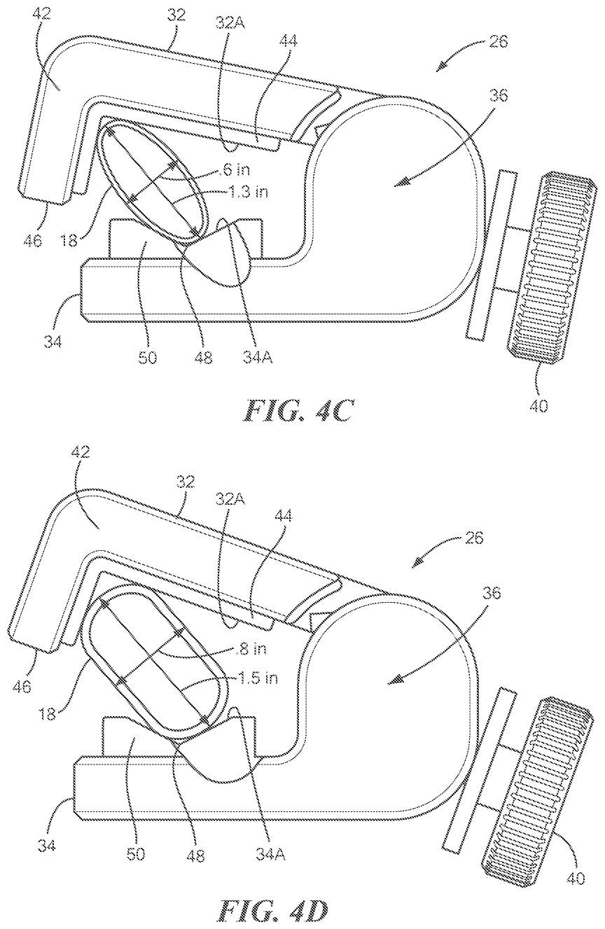

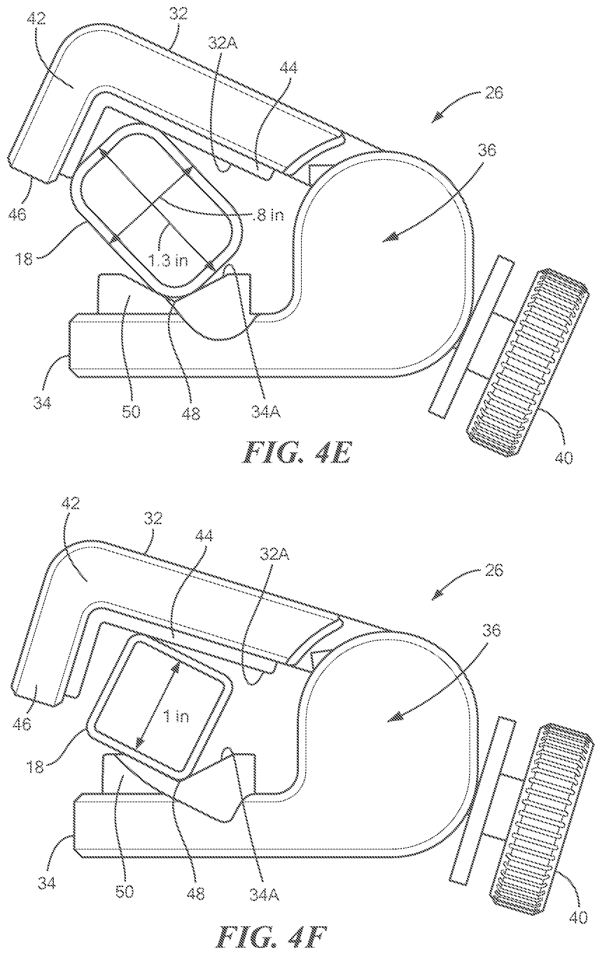

FIG. 3 schematically shows the clamp 26 broken apart, while FIGS. 4A-4F schematically show the clamp 26 removably coupled with a few examples of different base members 18 having different cross-sectional shapes. As shown, the clamp 26 has a top member 32 having a top inner surface 32A, and a corresponding bottom member 34 having a bottom inner surface 34A. These two inner surfaces in this example at least partially face each other to form a partially open containment chamber or gripping chamber. Specifically, in this embodiment, by partially facing each other, the larger, primary planes formed along the longitudinal axes of the two members converge and therefore intersect at an axis/pivot point 36 forming the point of connection. Preferably, this pivot point 36 is not removably connectable—it is intended to be a permanent connection (i.e., not able to removably connect unless forcibly separated or deconstructed).

In addition, the two members 32 and 34 in this embodiment are rotationally coupled about the pivot point 36 at their ends (on or near their right sides from the perspective of the drawings). As such, the two members 32 and 34 may be considered to form a claw-type mechanism that removably clamps onto the base member 18. Other embodiments may have a different coupling relationship to form the containment chamber. For example, such embodiments may position the top and bottom members 32 and 34 so that their inner surfaces 32A and 34A are generally parallel. In that case, a securing mechanism may urge the members 32 and 34 toward each other until locked on the base member 18. As such, the each member 32 or 34 is movable toward the other member 32 or 34 and thus, moves in a direction that is perpendicular to the other inner surface. When locked, depending on how the base member 18 couples with the clamp 26, the top and bottom inner surfaces 32A and 34A of this embodiment may diverge to some extent.

The clamp 26 preferably maintains its removable connection via a friction or interference fit secured by any of a variety of securing mechanisms. One embodiment may have an internal spring (not shown) that normally biases the two members toward each other. Other embodiments, including the one shown in the figures, has a tightening screw 38 with a round tightener 40 for applying a tightening force to the base member 18 and the arms, thus locking them together. In either case, the selected securing mechanism for coupling the clamp 26 allows for quick and easy attachment and release.

As shown, the top member 32 may be considered to be formed from a rigid layer 42 (e.g., plastic or metal) and a compressible, flexible inner layer 44 that forms the top inner surface 32A. For example, that compressible inner layer 44 may include one or more of silicone, rubber, felt, plastic, etc. Some embodiments of the top member 32, such as those shown in FIGS. 3-4F, also may have an integral or otherwise depending lip 46 that serves to further enclose or otherwise at least partially circumscribe the base member 18 when coupled. That depending lip 46 may also have a compressible inner layer 44 similar to that of the rest of the top inner surface 32A.

As shown in FIGS. 4A-4F, the bottom inner surface 34A is formed with a concavity 48 configured to cooperate with the top member 32 to releasably secure with a variety of types of base members 18. The concavity 48 can be engineered to have a precise contour to couple with a large number of cross-sectional shapes and sizes, or a less precise contour to have a wider variety of base members 18. There may be a tradeoff between range of base members 18 and secure fits. To those ends, the concavity 48 may be one or more of a rounded surface, angular surface, dimpled surface, irregularly shaped surface, etc. If a rounded surface, it is preferred that the concavity 48 have a large radius relative to the overall size of the clamp 26. This should enable an improved removable connection.

The concavity 48 may have a maximum depth that is specially selected to enable the clamp 26 to couple with ranges of base members 18. For example, the bottom member 34 may have a maximum thickness, and the concavity 48 may have a maximum depth. The ratio of the maximum depth may be between 0.1 and 0.7, between 0.1 and 0.6, or between 0.4 and 0.6. When formed as an angular surface, the concavity 48 preferably forms an angle of between 90 degrees and 170 degrees, or between 120 degrees and 150 degrees. Those skilled in the art can experiment and customize for specific cross-sectional shapes.

Some embodiments form the concavity 48 on an integral protrusion 50 extending upwardly from the bottom member 34. For example, FIGS. 4A-4F all show such an embodiment. This protrusion 50 may be formed from the noted compressible material, a soft/hard layered design, or a single hard layer. Rather than being an integral part of the bottom member 34, the protrusion 50 may be an extra component secured to the bottom member 34 (effectively becoming part of the bottom member 34). Whichever way, the inner surface at the concavity 48 or beyond may also have a compressible surface similar to that discussed above. In addition or alternatively, the bottom member 34 may have an ascending lip 46 structured in a similar manner to that noted above for the top member 32. Accordingly, one member or both members may have an ascending lip 46.

As noted, the clamp 26 is configured to couple with a plurality of differently sized surfaces or outer dimensions. This enables use with a wide variety of strollers 10 or wheelchairs having a wide variety of base member-types. Such a feature enhances the robustness and use of the mirror system 20, encouraging further use to assist with the noted child development benefits discussed above.

To demonstrate that benefit, FIGS. 4A-4F provide several examples of different cross-sectional shapes that may be useful for base members 18. It should be noted that the dimensions provided in the figures are merely exemplary and not intended to limit various embodiments. FIG. 4A shows a base member 18 with a circular cross-section with a relatively large diameter. As shown, the descending lip 46 and top member 32 secure a portion of the base member 18, while the remainder is secured at least in part within the concavity 48. In this figure, the base member 18 is partially seated in the concavity 48.

In a similar manner, FIG. 4B shows a base member 18 with a round but smaller cross-sectional diameter than that of FIG. 4A. In this example, the base member 18 may abut the top inner surface 32A and be fully seated within the concavity 48. From the perspective of FIG. 4B, the base member 18 contacts two angled lines representing the upwardly ascending portion(s) of the concavity 48 (which may be a single surface, but discussing in terms of the cross-sectional view in this manner for simplification purposes). The base member 18 in FIG. 4A, however, may be too large—extending the jaws of the clamp 26 as wide as they can be without fully seating the base member 18 in the concavity 48.

FIGS. 4C and 4D show examples of more elliptically shaped cross-sections of base members 18. Depending on the size, they may be fully engaged in the concavity 48 (e.g., as in FIG. 4B), or partly engaged in the concavity 48 (as in FIG. 4A). Both of these figures are shown as fully engaging with the concavity 48. FIGS. 4E and 4F show more rectangularly shaped cross-sectional base members 18. In this case, the cross-sectional shape of the base member 18 of FIG. 4E has flat sides but rounded corners, while the base member 18 of FIG. 4F has flat sides and sharper corners. Again, the descending lip 46 and concavity 48 cooperate with the compressed top inner surface 32A to apply a force to the base member outer surface. This force removably secures the mirror system 20 to the stroller 10.

It should be reiterated that these figures are schematic and as such, may not clearly show compression of the compressible layer. Nevertheless, some compression should be implied in these figures as a relatively hard member, the base member 18, abuts and thus applies an abutting/compression force to the compressible inner layer 44. Indeed, some embodiments may omit the compressible inner layer 44.

Beyond baby strollers 10 and wheelchairs, alternative embodiments also may apply to other movable platforms, such as boats, cars, treadmills, and other moving or stable objects. Moreover, some embodiments omit the clamp 26 and integrate the support arm 22 directly into a part of the stroller frame.

During use, a user removably secures the clamp 26 to the base member 18 of the movable platform. To provide an improved coupling/securing connection, the user may secure the clamp 26 to the base member 18 so that at least a portion of the support arm 22 is held upright. To that end, a securing force (e.g., via the noted spring or tightener 40) is applied to the top and bottom members 32 and 34 of the clamp 26 so that the top member 32 is biased at least partially toward the second member. For example, when forming a hinge, the claw-type clamp 26 is normally biased to a closed position in a manner similar to a clothespin.

The securing force at least partially deforms and compresses the compressible top inner surface 32A against the base member 18. In addition, the concavity 48 of the bottom inner surface 34A contacts with the base member 18 of the stroller 10. As shown in various figures, such as FIG. 4A, the base member 18 may be partially engaged in the concavity 48, or as in FIG. 4B, the base member 18 may be fully engaged in the concavity 48. This may provide a kinematic connection with the base member 18, minimizing freedom of movement of the clamp 26 in at least two dimensions.

The user them may adjust the mirror 24 to a desired position, such as one that enables the caregiver to make eye contact with the child when pushing the stroller 10. Indeed, this is an intended, direct force to which the support arm 22 is configured to yield. The caregiver or other user thus may adjust the position of the mirror 24 relative to the base while the clamp 26 is removably secured to the base. That may involve grasping the mirror 24 or support arm 22, thus moving the support arm 22 so that the mirror 24 at least partially faces in the direction of the handle 14—i.e., in the direction of the person pushing the stroller 10 via the handle(s) 14. Accordingly, one portion of the support arm 22 may be moved relative to another part of the support arm 22, or the entire support arm 22 may be moved. When finished, the user may remove the mirror system 20 from the base member 18 by applying a sufficient release force, overcoming the securing force applied to the base member 18. For example, the securing screw 38 may be unscrewed to some extent (using the tightener 40), or the user may apply a force to the proximal ends of the two members 32 and 34 when they are spring loaded to apply the removal force.

The embodiments of the invention described above are intended to be merely exemplary; numerous variations and modifications will be apparent to those skilled in the art. Such variations and modifications are intended to be within the scope of the present invention as defined by any of the appended claims.

What is claimed is:

1. A mirror system for use with a stroller or wheelchair, the mirror system comprising:
a mirror;
a support arm coupled with the mirror; and
a clamp coupled with the support arm, the mirror spaced from the clamp along the support arm,
the clamp comprising a first member having a first surface and a second member having a second surface, the first surface opposing the second surface, the first surface being compressible, the second surface having a concavity, the first surface being movable relative to the second surface.

2. The mirror system as defined by claim 1 wherein the mirror comprises a convex reflective surface.

3. The mirror system as defined by claim 1 wherein the support arm comprises a gooseneck having a flexible longitudinal member formed from a plurality of interconnected ring elements.

4. The mirror system as defined by claim 1 the clamp comprises a hinge pivotably coupling the first member and the second member at an axis, the hinge configured so that the first surface can move toward and away from the second surface.

5. The mirror system as defined by claim 1 wherein the first member is configured to move substantially perpendicularly toward the second member.

6. The mirror system as defined by claim 1 wherein the concavity forms an angled surface having an angle between 90 and 175 degrees.

7. The mirror system as defined by claim 1 wherein the concavity forms a curved surface.

8. The mirror system as defined by claim 1 wherein the second member has a maximum thickness, the concavity having a maximum depth in the second member, the ratio of the maximum depth and the thickness of the second member being between 0.1 and 0.6.

9. The mirror system as defined by claim 1 wherein the first member comprises a rigid inner layer and an outer silicone or rubber forming the first surface.

10. The mirror system as defined by claim 1 further comprising a ball joint movably coupling the mirror with the support arm.

11. The mirror system as defined by claim 1 wherein at least one of the first and second members includes a descending lip configured to form a containment chamber for supporting a base member.

12. The mirror system as defined by claim 11 wherein the descending lip comprises a compressible inner lip surface.

13. The mirror system as defined by claim 1 wherein the first and second surfaces are configured to cooperate to secure to a flat surface with at least a portion of the support arm being held upright, further wherein the first and second surfaces are configured to cooperate to secure to a convex surface with at least a portion of the support arm being held upright.

14. A method comprising:
providing a movable platform having wheels and a base member, the movable platform having a seat configured to support a person and a handle configured to enable application of a force to move the movable platform, the movable platform comprising a stroller or wheelchair;
removably securing a mirror system to the base member of the movable platform, the mirror system having a support arm coupled with both a mirror and a clamp, the clamp comprising a first member having a first surface and a second member having a second surface, the first surface opposing the second surface, the first surface being compressible, the second surface having a concavity, the first surface being movable relative to the second surface,
securing comprising securing the clamp to the base member so that at least a portion of the support arm is held upright, securing also comprising applying a securing force to the first and second members of the clamp so that the first member is biased at least partially toward the second member, the securing force at least partially deforming and compressing the compressible first surface against the base member,
securing further comprising contacting the concavity of the second surface with the base member of the movable platform; and
adjusting the position of the mirror relative to the base while the clamp is removably secured to the base, adjusting comprising moving the support arm and mirror so that the mirror at least partially faces in the direction of the handle.

15. The method as defined by claim 14 further comprising:
removing the mirror system from the base member, removing comprising reducing the securing force to cause the first and second members to lose contact with the base member.

16. The method as defined by claim 14 wherein the base member has a substantially flat surface facing the concavity of the second surface when removably secured.

17. The method as defined by claim 14 wherein the base member has base convex surface that contacts the concavity of the second surface when removably secured.

18. A mirror system comprising:
a mirror having a convex reflective surface;
a flexible gooseneck support arm coupled with the mirror, the support arm having a plurality of individual interconnected ring elements that are movable relative to each other to enable the support arm to change shapes in response to an applied force; and
a clamp coupled with the support arm, the clamp comprising a first member having a first surface and a second member having a second surface, the first surface opposing the second surface, the first surface being compressible, the second surface having a concavity that forms one of a curved surface or an angled surface, the first surface being movable relative to the second surface about a common axis,
the first and second surfaces being configured to cooperate to secure to a flat surface with at least a portion of the support arm being held upright, the first and second surfaces also configured to cooperate to secure to a convex surface with at least a portion of the support arm being held upright,
at least one of the first and second members comprising a descending lip configured to form a containment chamber for supporting a base member, the descending lip comprising a compressible inner lip surface.

19. The mirror system as defined by claim 18 further comprising means for normally biasing the first member toward the second member about the common axis.

20. The mirror system as defined by claim 19 wherein the first member comprises a rigid inner layer and an outer silicone or rubber forming the first surface.
